(19) United States
(12) Patent Application Publication
(10) Pub. No.: US 2012/0119986 A1
(43) Pub. Date: May 17, 2012

(54) THREE-DIMENSIONAL CONTROL APPARATUS OF COMPUTER INPUT DEVICE AND METHOD THEREOF

(75) Inventors: Ho-Sung WU, New Taipei City (TW); Chih-Min Liu, New Taipei City (TW)

(73) Assignee: KYE SYSTEMS CORP., New Taipei City (TW)

(21) Appl. No.: 13/218,605

(22) Filed: Aug. 26, 2011

(30) Foreign Application Priority Data
Nov. 17, 2010 (TW) 099139610

(51) Int. Cl. G09G 5/00

(52) U.S. Cl. 345/156

(57) ABSTRACT

A three-dimensional (3D) control apparatus for a computer input device, used to sense 3D motion relations to output multiple 3D control signals, includes a first element comprising a plurality of sensing units and a second element comprising a plurality of transmitting coils. Each sensing unit of the first element has two adjacent receiving coils. The second element is capable of performing a 3D multi-axial motion with respect to the first element to generate multiple 3D control signals according to relative position relations between the plurality of transmitting coils and the plurality of receiving coils, so as to perform 3D control.

### CROSS-REFERENCE TO RELATED APPLICATIONS

This non-provisional application claims priority under 35 U.S.C. §119(a) on Patent Application No(s). 099139610 filed in Taiwan, R.O.C. on Nov. 17, 2010, the entire contents of which are hereby incorporated by reference.

### BACKGROUND

1. Technical Field

The present disclosure relates to a signal control apparatus and a method thereof, and more particularly to a three-dimensional (3D) control apparatus for a computer input device and a method thereof.

2. Related Art

With the development of information technology, more and more peripheral electronic products are developed to meet the market requirements and enable a user to use a computer more easily. An existing pointing device is may be either a mouse or a graphics tablet. The user may select the pointing control system according to his or her requirements. For example, when using drawing software, the user may use the graphics tablet.

With the evolution of 3D drawing software and 3D display technology, the user has increasingly demanded to manipulate a 3D system with ease. However, a common pointing device, for example, a mouse most often used, only provides a two-dimensional input signal. If a common mouse is used to operate the 3D system, the user may have many difficulties to cope with.

In this regard, a 3D mouse is provided in the prior art for the user to send a multi-dimensional manipulation signal. A 3D mouse is disclosed in U.S. Pat. No. 6,753,519, which is characterized by that relative movements or relative positions between two objects are detected through arrangement of optical electronic devices.

However, if the relative movements or the relative positions of the objects are detected by using the optical electronic devices, an optical detection apparatus (for example, a charge-coupled device) needs to be used with a recognition program used for calculation of the relative movements or the relative positions. Therefore, components in the 3D mouse of the prior art is complex, and the production cost is high. Moreover, the light emitting device and the optical detection apparatus also occupy a certain amount of volume. In this case, the 3D mouse of the prior art will confront a big challenge in reducing the volume.

### SUMMARY

In order to prevent the problem in the prior art of the high production cost of the 3D mouse, the present disclosure relates to a low manufacturing cost 3D control apparatus for a computer input device.

The present disclosure provides a 3D control apparatus for a computer input device, which comprises at least three sensing units and at least one transmitting coil. Each sensing unit has two adjacent receiving coils. For control, the transmitting coil lies among the three sensing units and performs a multi-axial motion with respect to the three sensing units to change the relations of received signals of each receiving coil in the three sensing units.

The present disclosure further provides a 3D control apparatus for a computer input device, which comprises a first element and a second element. The first element comprises at least three sensing units, and each sensing unit has two adjacent receiving coils. The second element comprises at least one transmitting coil, which is disposed among the three sensing units. The first element and the second element are disposed in a relation of the first element being capable of performing a multi-axial motion with respect to the second element. The multi-axial motion of the transmitting coil with respect to the three sensing units may change relations of the received signal of each receiving coil. The three sensing units generate at least six types of control signals according to the received signals.

According to an embodiment, the present disclosure further discloses a 3D control apparatus for a computer input device, which comprises a first element and a second element. The first element comprises at least three sensing units, and each sensing unit has two adjacent receiving coils. The second element comprises at least three transmitting coils, which are disposed in a one-to-one manner with the three sensing units. The first element is disposed in a relation of being capable of performing a multi-axial motion relative to the second element. The multi-axial motion of the transmitting coils with respect to the three sensing units may change relation of the received signal of each receiving coil. The three sensing units generate at least ten types of control signals according to the received signals.

According to an embodiment of the present disclosure, the present disclosure further discloses a 3D control apparatus for a computer input device, which comprises a first element and a second element. The first element comprises at least four sensing units, and each sensing unit has two adjacent receiving coils. The second element comprises at least four transmitting coils, which are disposed in a one-to-one manner with the four sensing units. The first element is disposed in a relation of being capable of performing a multi-axial motion relative to the second element. The multi-axial motion of the transmitting coils may change the relation of the received signal of each receiving coil in the four sensing units corresponding to the four sensing units. The four sensing units generate at least twelve types of control signals according to the received signals.

According to an embodiment, the present disclosure further discloses a 3D control method of a computer input device. The 3D control method comprises: generating a plurality of control signals by using the strengths of corresponding signals generated between a first element and a second element, and performing a multi-axial direction control through the plurality of control signals.

According to the embodiments of the present disclosure, for performing 3D control, only a small number of transmitting coils and receiving coils are required to generate up to twelve types of control signals according to the relations of the received signals of the receiving coils. Therefore, the 3D control apparatus for the computer input device disclosed by the present disclosure has a rather simple structure, which not only saves the manufacturing cost, but also effectively reduces the volume to be more easily integrated with other computer peripheral apparatuses.

### BRIEF DESCRIPTION OF THE DRAWINGS

The present disclosure will become more fully understood from the detailed description given herein below for illustration only, and thus are not limitative of the present disclosure, and wherein:

FIG. 1 is a schematic diagram of a first embodiment of the present disclosure;

FIG. 2A, FIG. 2B, and FIG. 2C are schematic diagrams of position relations according to the first embodiment of the present disclosure;

FIG. 3A to FIG. 3L are schematic diagrams of multi-axial motions according to the first embodiment of the present disclosure;

FIG. 4A and FIG. 4B are schematic diagrams of relative positions according to a second embodiment of the present disclosure;

FIG. 5 is a schematic diagram of a third embodiment of the present disclosure;

FIG. 6A and FIG. 6B are schematic diagrams of position relations according to the third embodiment of the present disclosure;

FIG. 7 is a schematic diagram of a fourth embodiment of the present disclosure;

FIG. 8A and FIG. 8B are schematic diagrams of relative positions according to the fourth embodiment of the present disclosure; and

FIG. 9 is a flow chart of a 3D control method according to the present disclosure.

### DETAILED DESCRIPTION

The detailed features and advantages of the present disclosure are described below in great detail through the following embodiments, and the content of the detailed description is sufficient for people skilled in the art to understand the technical content of the present disclosure and to implement the present disclosure there accordingly. Based upon the content of the specification, the claims, and the drawings, people skilled in the art can easily understand the relevant objectives and advantages of the present disclosure.

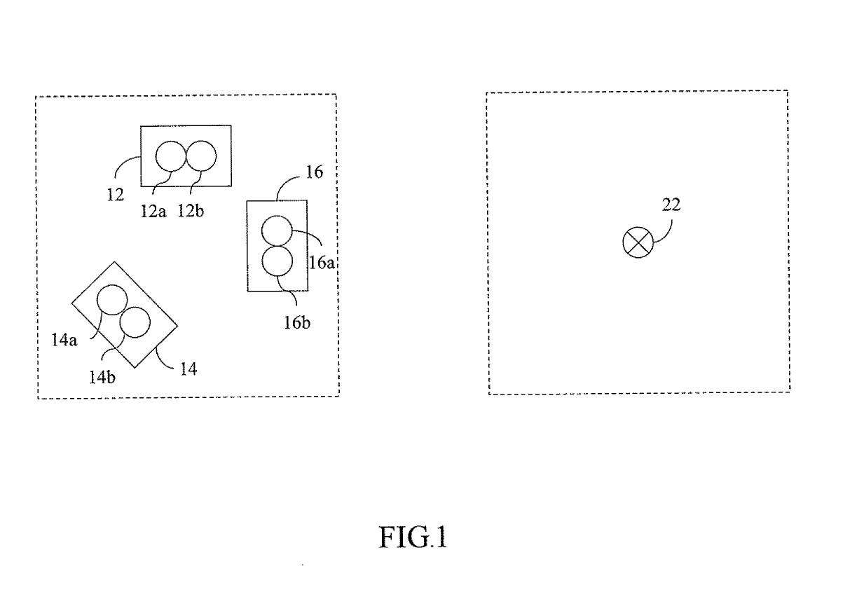

FIG. 1 is a schematic diagram of a first embodiment of the present disclosure. A 3D control apparatus for a computer input device comprises three sensing units and a first transmitting coil 22. In this embodiment, the three sensing units are respectively a first sensing unit 12, a second sensing unit 14, and a third sensing unit 16.

Each sensing unit comprises two adjacent receiving coils. Thus, the first sensing unit 12 comprises a first receiving coil 12a and a second receiving coil 12b, and the edges of the first receiving coil 12a and the second receiving coil 12b are adjacent to each other. Similarly, the second sensing unit 14 comprises a third receiving coil 14a and a fourth receiving coil 14b adjacent to each other, and the third sensing unit 16 comprises a fifth receiving coil 16a and a sixth receiving coil 16b adjacent to each other.

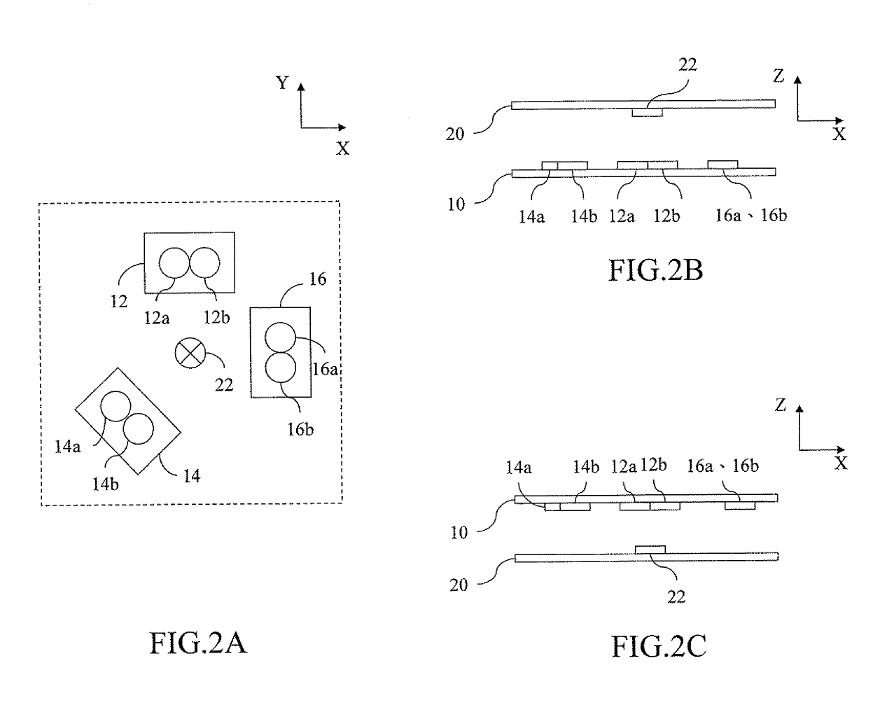

FIG. 2A is a schematic diagram of position relations according to the first embodiment of the present disclosure. As viewed overhead, the first transmitting coil 22 lies among the first sensing unit 12, the second sensing unit 14, and the third sensing unit 16. The distances from the first transmitting coil 22 to the first sensing unit 12, the second sensing unit 14, and the third sensing unit 16 are equal. The first sensing unit 12, the second sensing unit 14, and the third sensing unit 16 are respectively located in angular directions of 90 degrees, 210 degrees, and 0 degree of the first transmitting coil 22.

FIG. 2B and FIG. 2C are the side views of position relations according to the first embodiment of the present disclosure.

In FIG. 2B, the first sensing unit 12, the second sensing unit 14, and the third sensing unit 16 may be disposed on a surface of a first element 10. The first transmitting coil 22 may be disposed on a surface of a second element 20. The second element 20 is located over the first element 10. A user may manipulate the second element 20 to perform a multi-axial motion control.

In FIG. 2C, the first sensing unit 12, the second sensing unit 14, and the third sensing unit 16 may be disposed on a surface of the first element 10. The first transmitting coil 22 may be disposed on a surface of the second element 20. The first element 10 is located over the second element 20. A user may manipulate the first element 10 to perform a multi-axial motion control.

When the first transmitting coil 22 performs the multi-axial motion with respect to the first sensing unit 12, the second sensing unit 14, and the third sensing unit 16, receiving coils 12a, 12b, 14a, 14b, 16a, 16b in the first sensing unit 12, the second sensing unit 14, and the third sensing unit 16 may receive signals with different strengths respectively. Relations among the signals with different strengths may be transmitted to a digital processing apparatus by which the received signals with different strengths are converted into control signals to perform 3D control. The received signals corresponding to the multi-axial motion are described as follows.

The multi-axial motion at least comprises forward, backward, leftward, and rightward shift and upward, downward displacement. In the present disclosure, “forward” is defined as a direction of Y axis in FIG. 2A; “backward” is defined as a direction opposite to the direction of Y axis in FIG. 2A; “leftward” is defined as a direction opposite to a direction of X axis in FIG. 2A; “rightward” is defined as the direction of X axis in FIG. 2A; “upward” is defined as a direction of Z axis in FIG. 2B or FIG. 2C, and “downward” is defined as a direction opposite to the direction of Z axis in FIG. 2B or FIG. 2C.

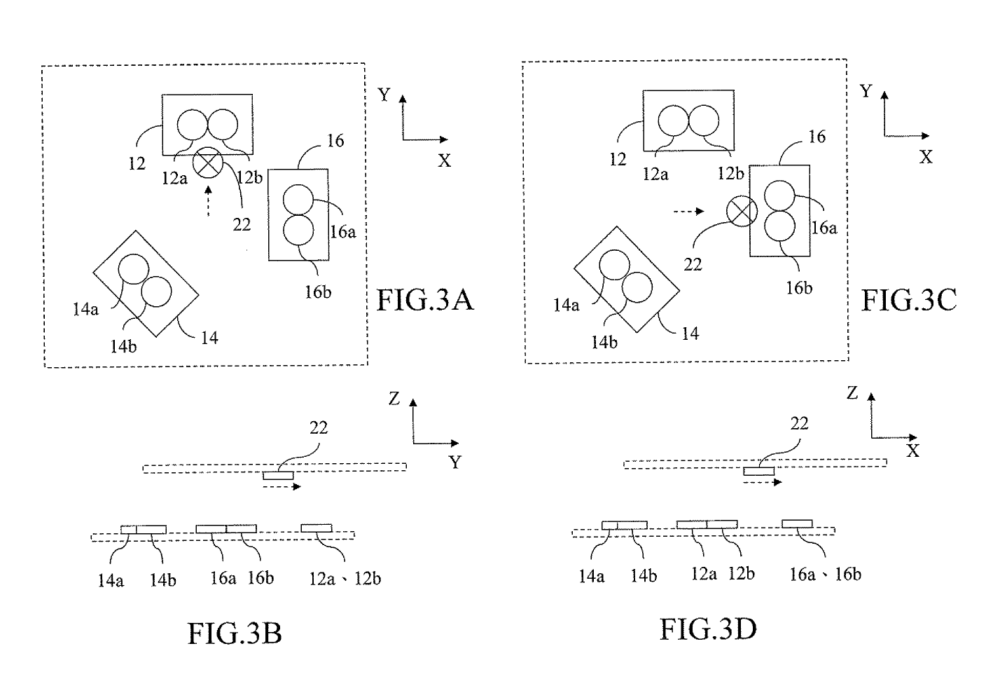

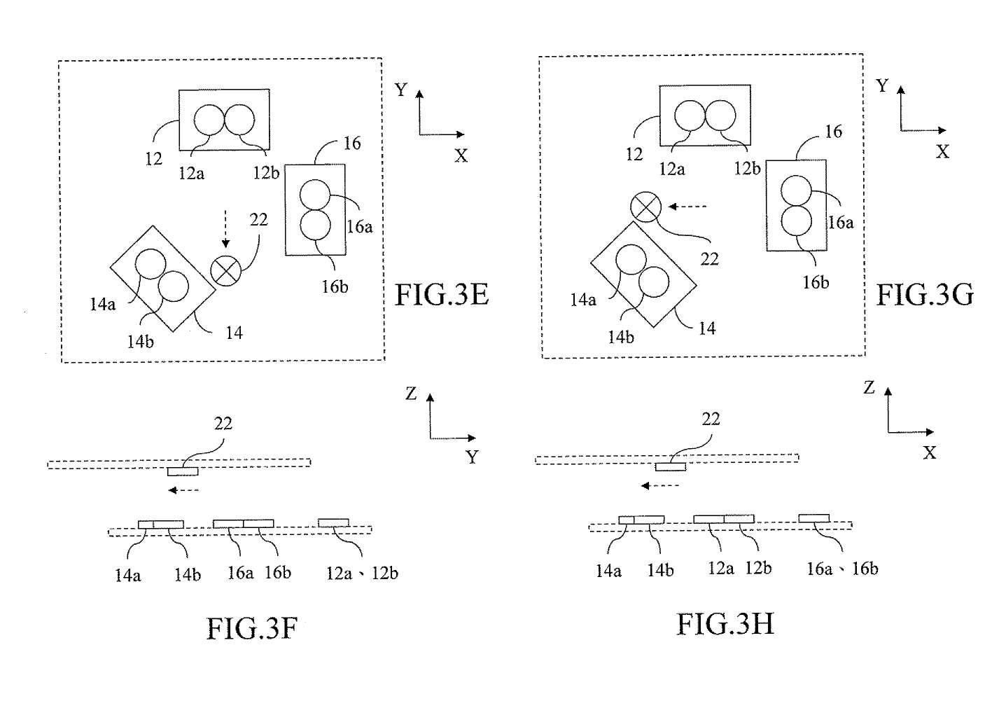

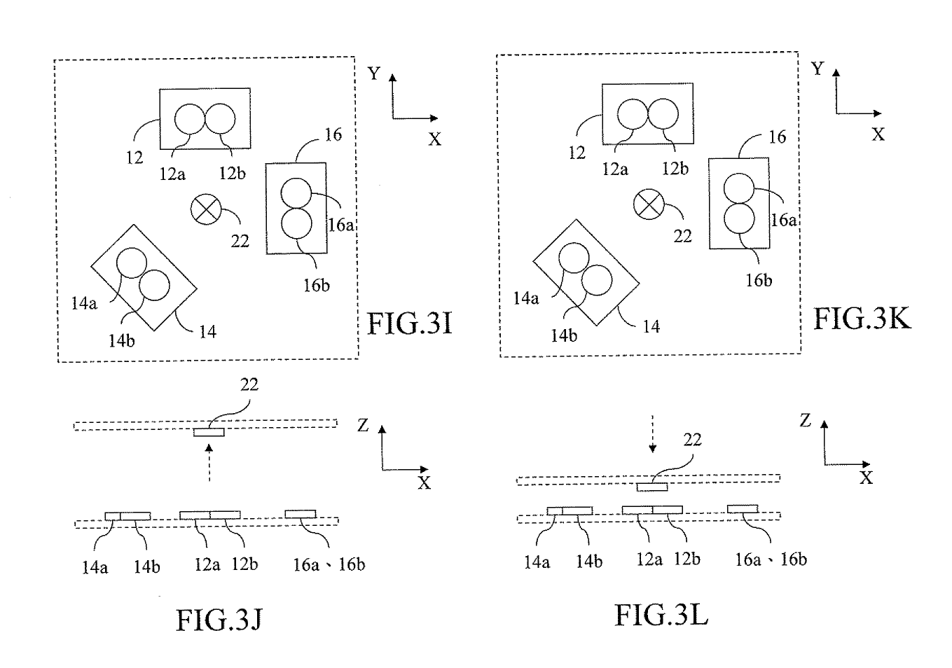

FIG. 3A to FIG. 3L are schematic diagrams of multi-axial motions according to the first embodiment of the present disclosure.

In FIG. 3A and FIG. 3B, when the first transmitting coil 22 is moved in a forward direction (the direction of Y axis), the first transmitting coil 22 moves in a direction approaching the first receiving coil 12a and the second receiving coil 12b. Meanwhile, the first transmitting coil 22 is away from the third receiving coil 14a, the fourth receiving coil 14b, the fifth receiving coil 16a, and the sixth receiving coil 16b. Therefore, the strength of signals received by the first receiving coil 12a and the second receiving coil 12b is increased, and the strength of signals received by the third receiving coil 14a, the fourth receiving coil 14b, the fifth receiving coil 16a, and the sixth receiving coil 16b is reduced.

In FIG. 3C and FIG. 3D, when the first transmitting coil 22 is moved in a rightward direction (the direction of X axis), the first transmitting coil 22 moves in a direction approaching the fifth receiving coil 16a and the sixth receiving coil 16b. Meanwhile, the first transmitting coil 22 is away from the first receiving coil 12a, the second receiving coil 12b, the third receiving coil 14a, and the fourth receiving coil 14b. Therefore, the strength of signals received by the fifth receiving coil 16a and the sixth receiving coil 16b is increased, and the strength of signals received by the first receiving coil 12a, the second receiving coil 12b, the third receiving coil 14a, and the fourth receiving coil 14b is reduced.

In FIG. 3E and FIG. 3F, when the first transmitting coil 22 is moved in a backward direction (the direction opposite to that of Y axis), the first transmitting coil 22 moves in a direction approaching the third receiving coil 14a and the fourth receiving coil 14b. Meanwhile, the first transmitting coil 22 is away from the first receiving coil 12a, the second receiving coil 12b, the fifth receiving coil 16a, and the sixth receiving coil 16b. Moreover, the distance from the first transmitting coil 22 to the fourth receiving coil 14b is smaller than the distance from the first transmitting coil 22 to the third receiving coil 14a. Therefore, the strength of signals received by the first receiving coil 12a, the second receiving coil 12b, the fifth receiving coil 16a, and the sixth receiving coil 16b is reduced, and the strength of signals received by the third receiving coil 14a and the fourth receiving coil 14b is increased. The strength of signals received by the fourth receiving coil 14b is larger than the strength of signals received by the third receiving coil 14a.

In FIG. 3G and FIG. 3H, when the first transmitting coil 22 is moved in a leftward direction (the direction opposite to that of X axis), the first transmitting coil 22 moves in a direction approaching the third receiving coil 14a and the fourth receiving coil 14b. Meanwhile, the first transmitting coil 22 is away from the first receiving coil 12a, the second receiving coil 12b, the fifth receiving coil 16a, and the sixth receiving coil 16b. Moreover, the distance from the first transmitting coil 22 to the third receiving coil 14a is smaller than the distance from the first transmitting coil 22 to the fourth receiving coil 14b. Therefore, the strength of signals received by the first receiving coil 12a, the second receiving coil 12b, the fifth receiving coil 16a, and the sixth receiving coil 16b is reduced, and the strength of signals received by the third receiving coil 14a and the fourth receiving coil 14b is increased. The strength of signals received by the third receiving coil 14a is larger than the strength of signals received by the fourth receiving coil 14b.

In FIG. 3I and FIG. 3J, when the first transmitting coil 22 is moved in an upward direction (the direction of Z axis), the first transmitting coil 22 moves away from the first receiving coil 12a, the second receiving coil 12b, the third receiving coil 14a, the fourth receiving coil 14b, the fifth receiving coil 16a, and the sixth receiving coil 16b at the same time. Therefore, the strength of signals received by the first receiving coil 12a, the second receiving coil 12b, the third receiving coil 14a, the fourth receiving coil 14b, the fifth receiving coil 16a, and the sixth receiving coil 16b is all reduced.

In FIG. 3K and FIG. 3L, when the first transmitting coil 22 is moved in a downward direction (the direction opposite to that of Z axis), the first transmitting coil 22 moves in a direction approaching the first receiving coil 12a, the second receiving coil 12b, the third receiving coil 14a, the fourth receiving coil 14b, the fifth receiving coil 16a, and the sixth receiving coil 16b at the same time. Therefore, the strength of signals received by the first receiving coil 12a, the second receiving coil 12b, the third receiving coil 14a, the fourth receiving coil 14b, the fifth receiving coil 16a, and the sixth receiving coil 16b is all increased.

In this manner, according to relations of relative magnitudes (increased or reduced) of the signals received by the first receiving coil 12a, the second receiving coil 12b, the third receiving coil 14a, the fourth receiving coil 14b, the fifth receiving coil 16a, and the sixth receiving coil 16b, as well as the magnitudes of signals between the fifth receiving coil 16a and the sixth receiving coil 16b, six types of control signals may be generated in accordance with the “upward”, “downward”, “leftward”, “rightward”, “forward”, and “backward” movements respectively.

The above operation manner is to determine the relation of the relative magnitudes of the signals. If the received signal is converted into a digital signal of a plurality of bits, more types of control signals may be generated to correspond to different operations, such as “forward inclination”, “backward inclination”, “leftward inclination”, and “rightward inclination”.

The 3D control apparatus for the computer input device may be integrated into a common computer peripheral apparatus (for example, a mouse or a keyboard), or integrated into a handheld digital apparatus to facilitate the user's operation.

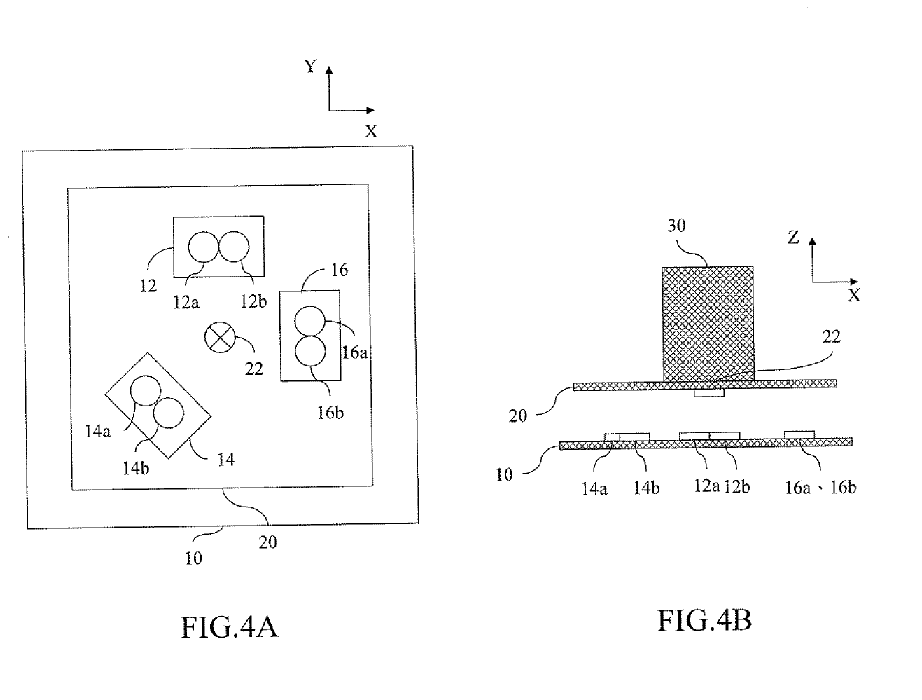

FIG. 4A and FIG. 4B are schematic diagrams of relative positions according to a second embodiment of the present disclosure. A 3D control apparatus for a computer input device disclosed by the present disclosure comprises a first element 10 and a second element 20. The 3D control apparatus may be regarded as an application of the foregoing 3D control apparatus.

The first element 10 comprises a first sensing unit 12, a second sensing unit 14, and a third sensing unit 16. Each sensing unit comprises two adjacent receiving coils. Thus, the first sensing unit 12 comprises a first receiving coil 12a and a second receiving coil 12b, and the edges of the first receiving coil 12a and the second receiving coil 12b are adjacent to each other. Similarly, the second sensing unit 14 comprises a third receiving coil 14a and a fourth receiving coil 14b adjacent to each other, and the third sensing unit 16 comprises a fifth receiving coil 16a and a sixth receiving coil 16b adjacent to each other.

The second element 20 comprises a first transmitting coil 22, and the first transmitting coil 22 lies among the first sensing unit 12, the second sensing unit 14, and the third sensing unit 16.

The first element 10 may be a base and fixed onto other apparatuses. A bar 30 is provided on the second element 20. The first element 10 and the second element 20 may be connected together through a spring or other connection element, so that a user may operate the bar 30 on the second element 20 to perform a multi-axial motion.

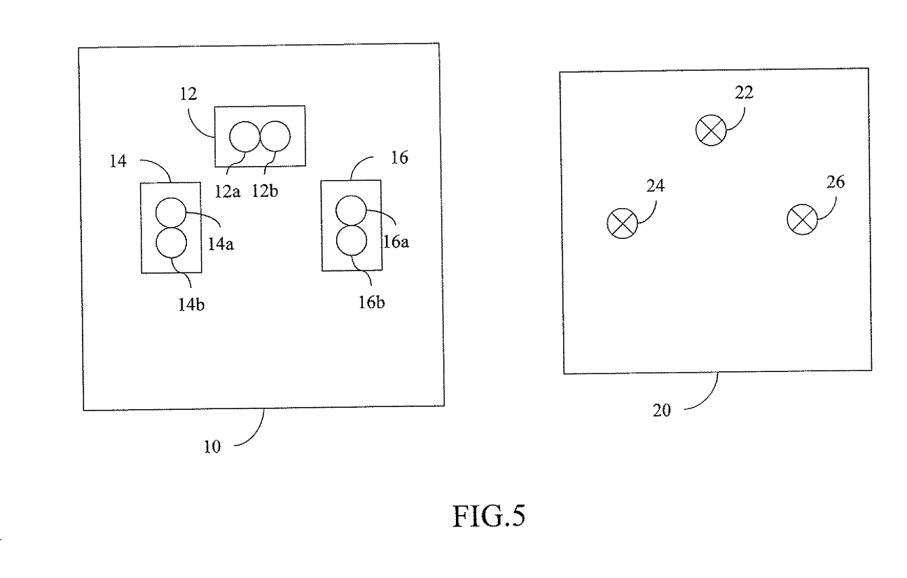

FIG. 5 is a schematic diagram of a third embodiment of the present disclosure. Referring to FIG. 5, a 3D control apparatus for a computer input device provided by the present disclosure comprises a first element 10 and a second element 20.

The first element 10 comprises a first sensing unit 12, a second sensing unit 14, and a third sensing unit 16. The first sensing unit 12 is disposed in an angular direction of 90 degrees of a center point of the first element 10; the second sensing unit 14 is disposed in an angular direction of 180 degrees of the center point of the first element 10, and the third sensing unit 16 is configured in an angular direction of 0 degree of the center point of the first element 10. The first sensing unit 12 comprises a first receiving coil 12a and a second receiving coil 12b adjacent to each other, and the first receiving coil 12a is disposed on the left of the second receiving coil 12b. The second sensing unit 14 comprises a third receiving coil 14a and a fourth receiving coil 14b adjacent to each other and the third receiving coil 14a is disposed on top of the fourth receiving coil 14b. The third sensing unit 16 comprises a fifth receiving coil 16a and a sixth receiving coil 16b adjacent to each other and the fifth receiving coil 16a is disposed on top of the sixth receiving coil 16b.

The second element 20 comprises a first transmitting coil 22, a second transmitting coil 24, and a third transmitting coil 26.

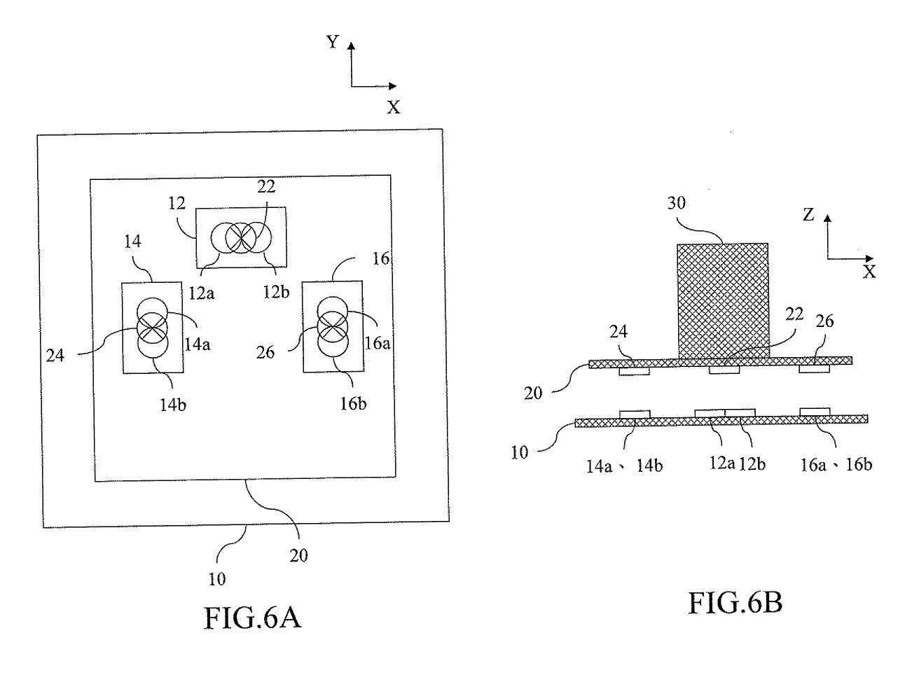

FIG. 6A and FIG. 6B are schematic diagrams of relative positions according to the third embodiment of the present disclosure. A bar 30 is provided on the second element 20. A user may operate the bar 30 to enable the second element 20 to perform a multi-axial motion with respect to the first element 10.

The first transmitting coil 22, the second transmitting coil 24, and the third transmitting coil 26 are disposed in a one-to-one manner with the first sensing unit 12, the second sensing unit 14, and the third sensing unit 16. Furthermore, the first transmitting coil 22 is disposed over and between the first receiving coil 12a and the second receiving coil 12b; the second transmitting coil 24 is disposed over and between the third receiving coil 14a and the fourth receiving coil 14b, and the third transmitting coil 26 is disposed over and between the fifth receiving coil 16a and the sixth receiving coil 16b.

When the second element 20 is moved in a forward direction, the first transmitting coil 22 moves away from the first receiving coil 12a and the second receiving coil 12b. Meanwhile, the second transmitting coil 24 is close to the third receiving coil 14a and away from the fourth receiving coil 14b, and the third transmitting coil 26 is close to the fifth receiving coil 16a and away from the sixth receiving coil 16b. Therefore, the strength of signals received by the third receiving coil 14a and the fifth receiving coil 16a is increased, and the strength of signals received by the first receiving coil 12a, the second receiving coil 12b, the fourth receiving coil 14b, and the sixth receiving coil 16b is reduced.

When the second element 20 is moved in a rightward direction, the first transmitting coil 22 moves close to the second receiving coil 12b and away from the first receiving coil 12a; the second transmitting coil 24 is away from the third receiving coil 14a and the fourth receiving coil 14b at the same time, and the third transmitting coil 26 is also away from the fifth receiving coil 16a and the sixth receiving coil 16b. Therefore, the strength of signals received by the second receiving coil 12b is increased, and the strength of signals received by the first receiving coil 12a, the third receiving coil 14a, the fourth receiving coil 14b, the fifth receiving coil 16a, and the sixth receiving coil 16b is reduced.

When the second element 20 is moved in a backward direction, the first transmitting coil 22 moves away from the first receiving coil 12a and the second receiving coil 12b. Meanwhile, the second transmitting coil 24 is close to the fourth receiving coil 14b and away from the third receiving coil 14a, and the third transmitting coil 26 is close to the sixth receiving coil 16b and away from the fifth receiving coil 16a. Therefore, the strength of signals received by the fourth receiving coil 14b and the sixth receiving coil 16b is increased, and the strength of signals received by the first receiving coil 12a, the second receiving coil 12b, the third receiving coil 14a, and the fifth receiving coil 16a is reduced.

When the second element 20 is moved in a leftward direction, the first transmitting coil 22 moves close to the first receiving coil 12a and away from the second receiving coil 12b; the second transmitting coil 24 is away from the third receiving coil 14a and the fourth receiving coil 14b at the same time, and the third transmitting coil 26 is also away from the fifth receiving coil 16a and the sixth receiving coil 16b at the same time. Therefore, the strength of signals received by the first receiving coil 12a is increased, and the strength of signals received by the second receiving coil 12b, the third receiving coil 14a, the fourth receiving coil 14b, the fifth receiving coil 16a, and the sixth receiving coil 16b is reduced.

When the second element 20 is moved in an upward direction, the first transmitting coil 22 moves away from the first receiving coil 12a and the second receiving coil 12b; the second transmitting coil 24 is away from the third receiving coil 14a and the fourth receiving coil 14b, and the third transmitting coil 26 is away from the fifth receiving coil 16a and the sixth receiving coil 16b. Therefore, the strength of signals received by the first receiving coil 12a, the second receiving coil 12b, the third receiving coil 14a, the fourth receiving coil 14b, the fifth receiving coil 16a, and the sixth receiving coil 16b is all reduced.

When the second element 20 is moved in a downward direction, the first transmitting coil 22 moves close to the first receiving coil 12a and the second receiving coil 12b; the second transmitting coil 24 is close to the third receiving coil 14a and the fourth receiving coil 14b, and the third transmitting coil 26 is close to the fifth receiving coil 16a and the sixth receiving coil 16b. Therefore, the strength of signals received by the first receiving coil 12a, the second receiving coil 12b, the third receiving coil 14a, the fourth receiving coil 14b, the fifth receiving coil 16a, and the sixth receiving coil 16b is all increased.

When the second element 20 is rotated in a rightward direction (clockwise), the first transmitting coil 22 moves close to the second receiving coil 12b and away from the first receiving coil 12a; the second transmitting coil 24 is close to the third receiving coil 14a and away from the fourth receiving coil 14b, and the third transmitting coil 26 is close to the sixth receiving coil 16b and away from the fifth receiving coil 16a. Therefore, the strength of signals received by the second receiving coil 12b, the third receiving coil 14a, and the sixth receiving coil 16b is increased, and the strength of signals received by the first receiving coil 12a, the fourth receiving coil 14b, and the fifth receiving coil 16a is reduced.

When the second element 20 is rotated in a leftward direction (counter-clockwise), the first transmitting coil 22 moves close to the first receiving coil 12a and away from the second receiving coil 12b; the second transmitting coil 24 is close to the fourth receiving coil 14b and away from the third receiving coil 14a, and the third transmitting coil 26 is close to the fifth receiving coil 16a and away from the sixth receiving coil 16b. Therefore, the strength of signals received by the first receiving coil 12a, the fourth receiving coil 14b, and the fifth receiving coil 16a is increased, and the strength of signals received by the second receiving coil 12b, the third receiving coil 14a, and the sixth receiving coil 16b is reduced.

When the second element 20 inclines in a rightward direction, the first transmitting coil 22 moves close to the second receiving coil 12b and away from the first receiving coil 12a; the second transmitting coil 24 is away from the third receiving coil 14a and the fourth receiving coil 14b, and the third transmitting coil 26 is close to the fifth receiving coil 16a and the sixth receiving coil 16b. Therefore, the strength of signals received by the second receiving coil 12b, the fifth receiving coil 16a, and the sixth receiving coil 16b is increased, and the strength of signals received by the first receiving coil 12a, the third receiving coil 14a, and the fourth receiving coil 14b is reduced.

When the second element 20 inclines in a leftward direction, the first transmitting coil 22 moves close to the first receiving coil 12a and away from the second receiving coil 12b; the second transmitting coil 24 is close to the third receiving coil 14a and the fourth receiving coil 14b, and the third transmitting coil 26 is away from the fifth receiving coil 16a and the sixth receiving coil 16b. Therefore, the strength of signals received by the first receiving coil 12a, the third receiving coil 14a, and the fourth receiving coil 14b is increased, and the strength of signals received by the second receiving coil 12b, the fifth receiving coil 16a, and the sixth receiving coil 16b is reduced.

In this manner, according to relations of relative magnitudes (increased or reduced) of the signals received by the first receiving coil 12a, the second receiving coil 12b, the third receiving coil 14a, the fourth receiving coil 14b, the fifth receiving coil 16a, and the sixth receiving coil 16b, ten types of control signals may be generated in accordance with the “upward”, “downward”, “leftward”, “rightward”, “forward”, “backward”, “leftward rotation”, “rightward rotation”, “leftward inclination”, and “rightward inclination” operations respectively.

The above operation manner is to generate the changes of magnitudes of the signals. If the received signal is converted into a digital signal of a plurality of bits, more types of control signals may be generated corresponding to different operations, such as “forward inclination” and “backward inclination”.

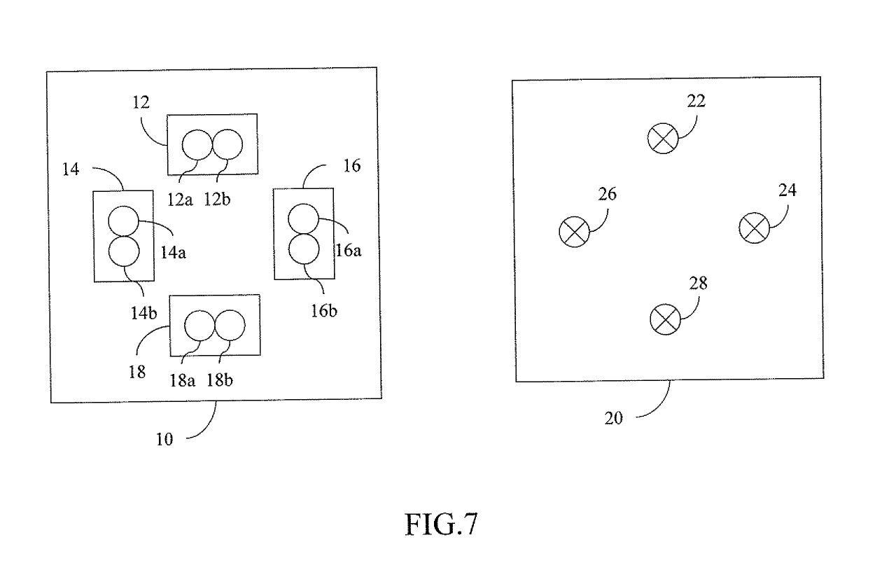

FIG. 7 is a schematic diagram of a fourth embodiment of the present disclosure. A 3D control apparatus for a computer input device provided by the present disclosure comprises a first element 10 and a second element 20.

The first element 10 comprises a first sensing unit 12, a second sensing unit 14, a third sensing unit 16, and a fourth sensing unit 18. The first sensing unit 12 is disposed in an angular direction of 90 degrees of a center point of the first element 10; the second sensing unit 14 is disposed in an angular direction of 180 degrees of the center point of the first element 10; the third sensing unit 16 is disposed in an angular direction of 0 degree of the center point of the first element 10, and the fourth sensing unit 18 is disposed in an angular direction of 270 degrees of the center point of the first element 10. The first sensing unit 12 comprises the first receiving coil 12a and the second receiving coil 12b adjacent to each other, and the first receiving coil 12a is disposed on the left of the second receiving coil 12b. The second sensing unit 14 comprises the third receiving coil 14a and the fourth receiving coil 14b adjacent to each other, and the third receiving coil 14a is disposed over the fourth receiving coil 14b. The third sensing unit 16 comprises the fifth receiving coil 16a and the sixth receiving coil 16b adjacent to each other, and the fifth receiving coil 16a is disposed over the sixth receiving coil 16b. The fourth sensing unit 18 comprises a seventh receiving coil 18a and an eighth receiving coil 18b adjacent to each other and the seventh receiving coil 18a is disposed on the left of the eighth receiving coil 18b.

The second element 20 comprises a first transmitting coil 22, a second transmitting coil 24, a third transmitting coil 26, and a fourth transmitting coil 28.

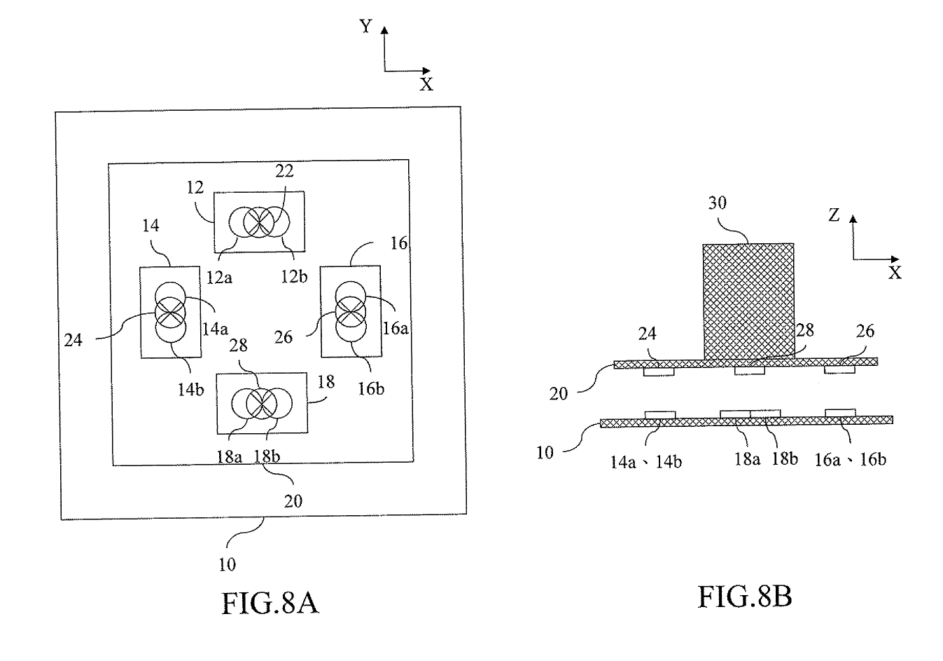

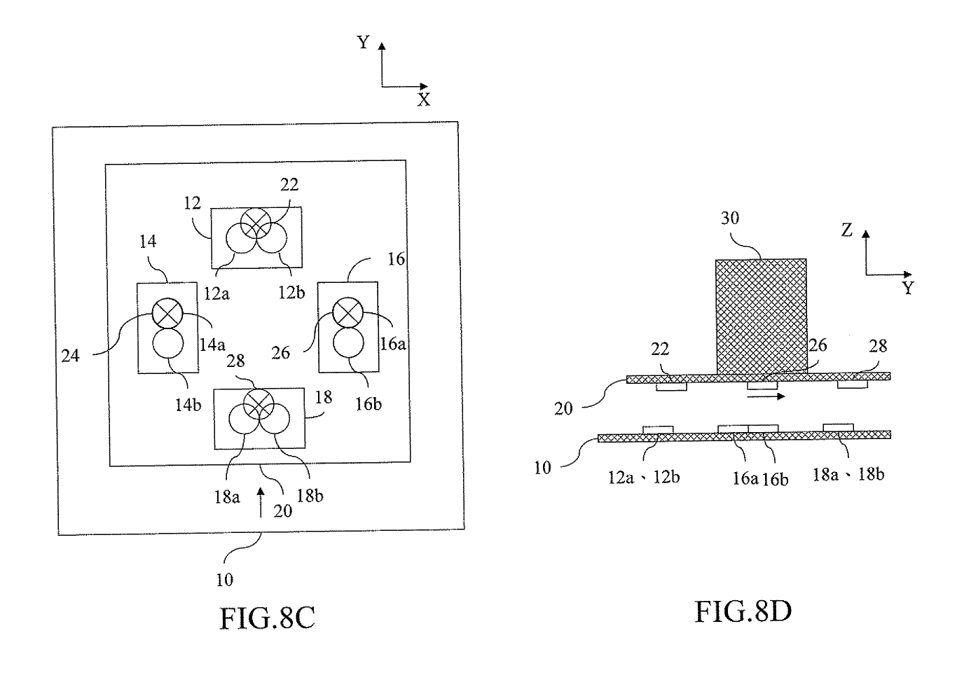

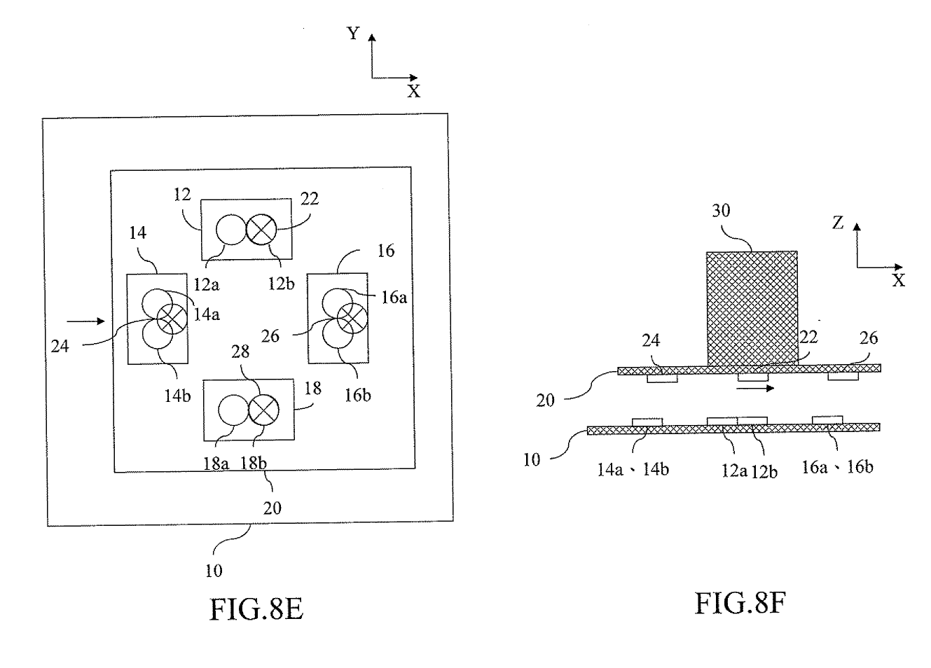

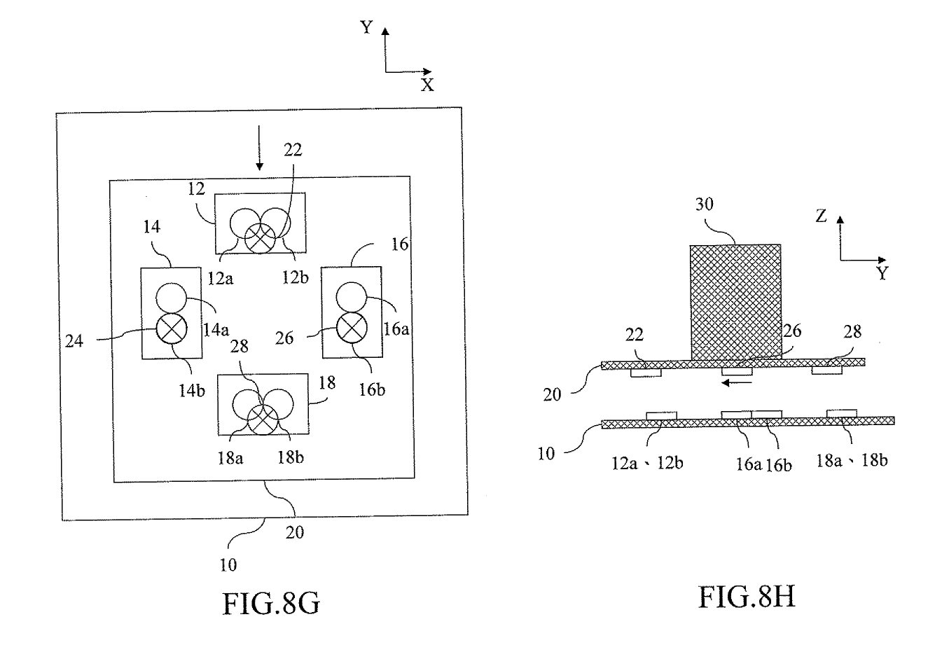

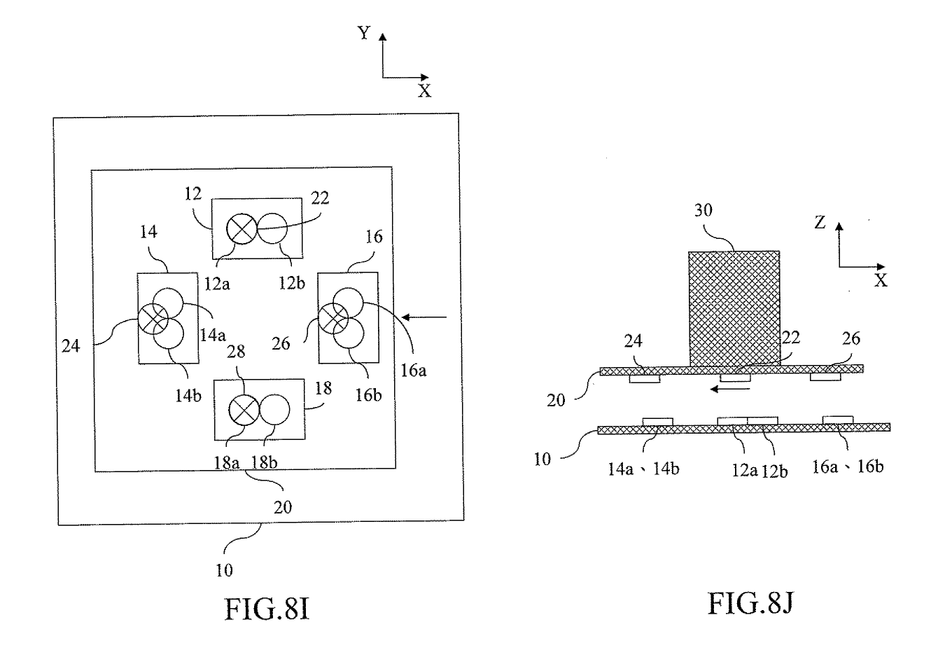

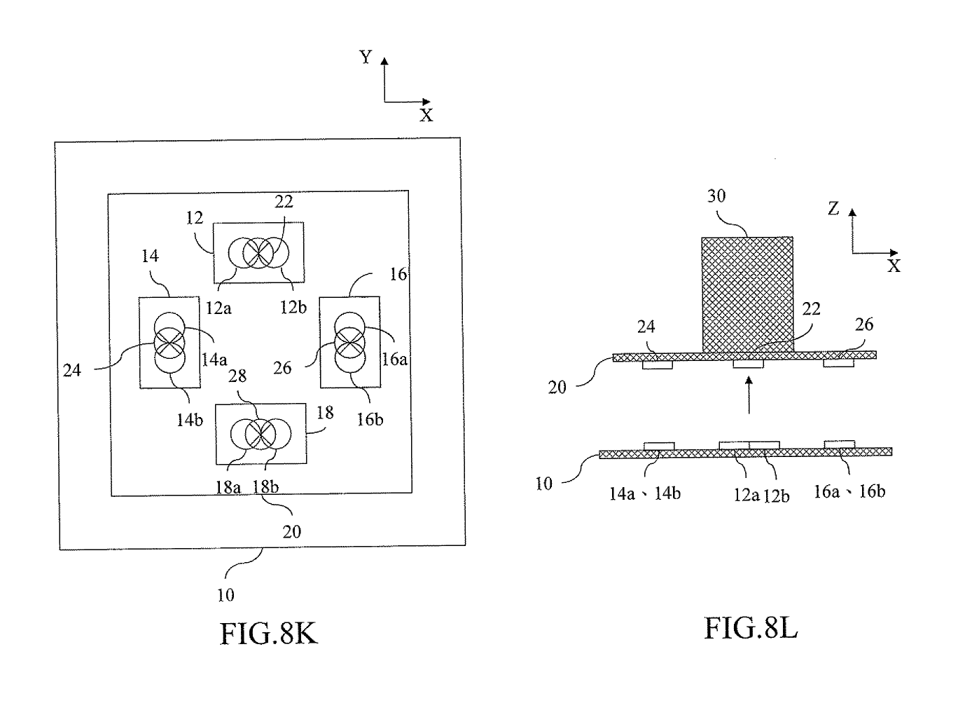

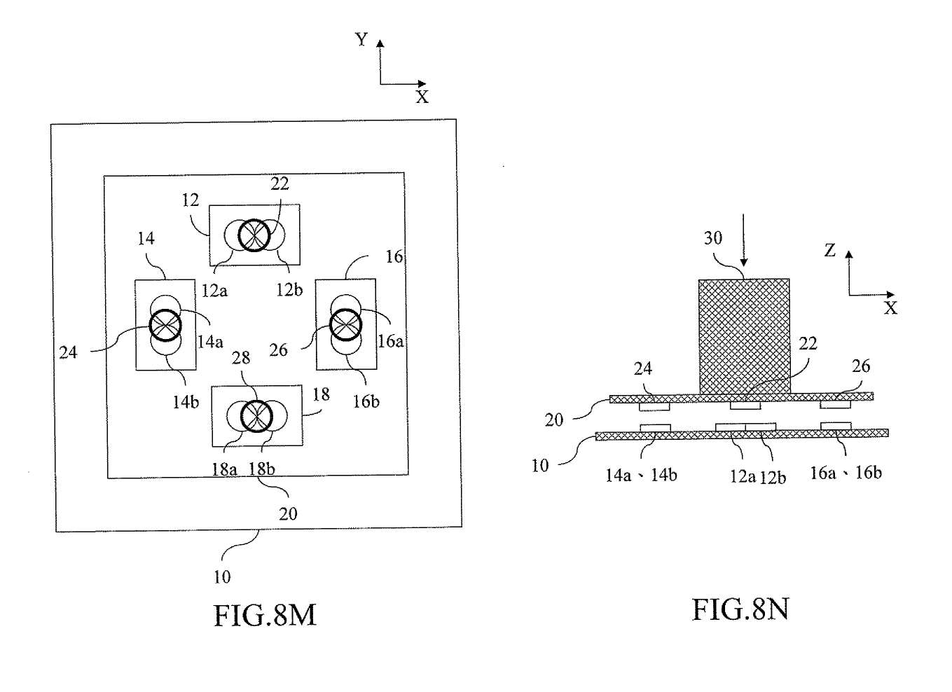

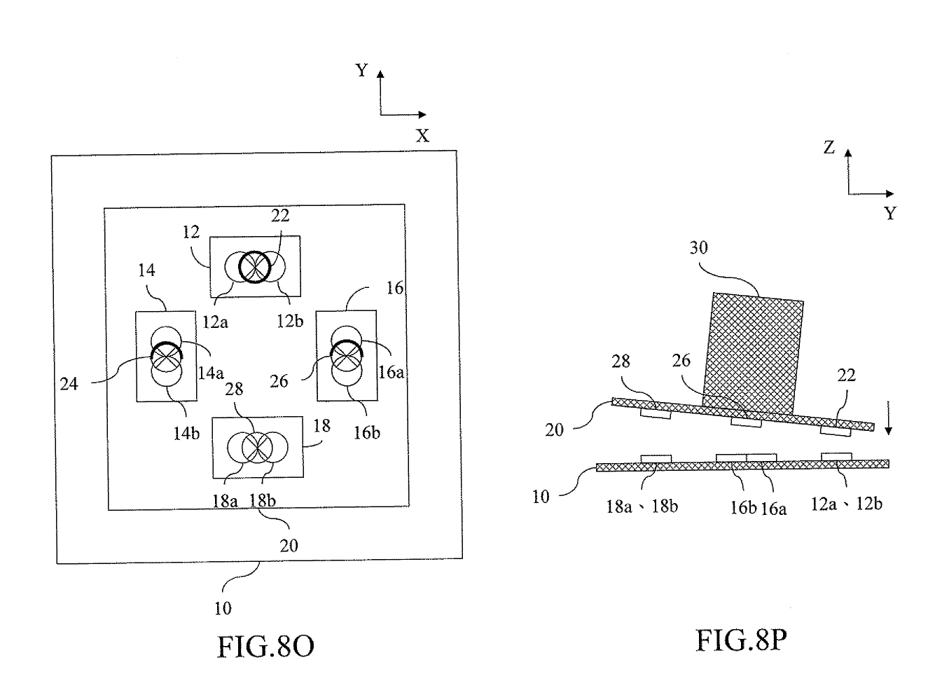

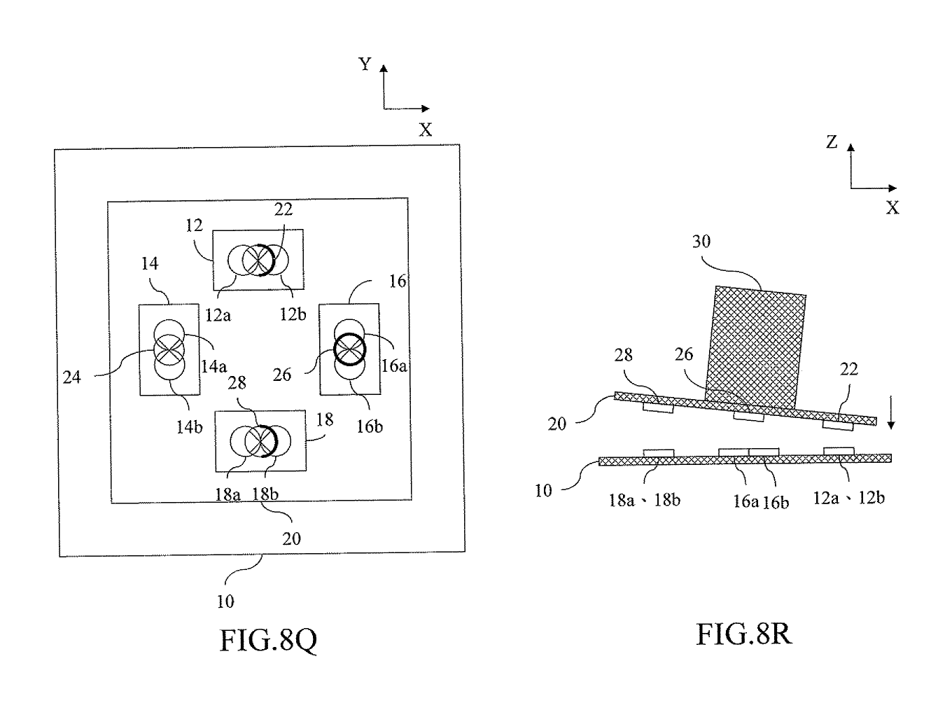

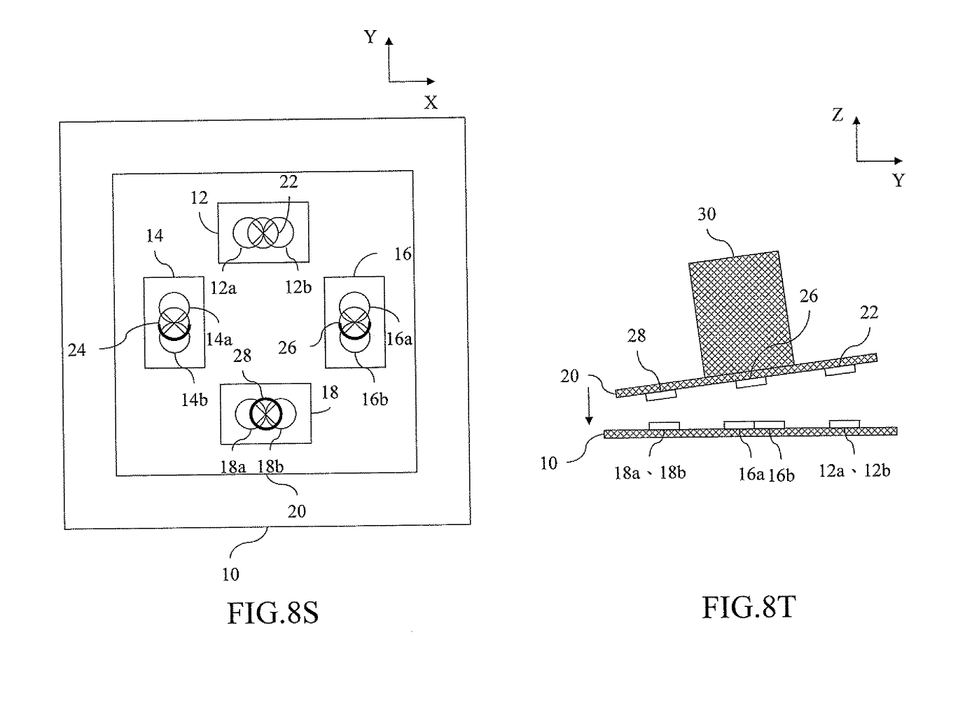

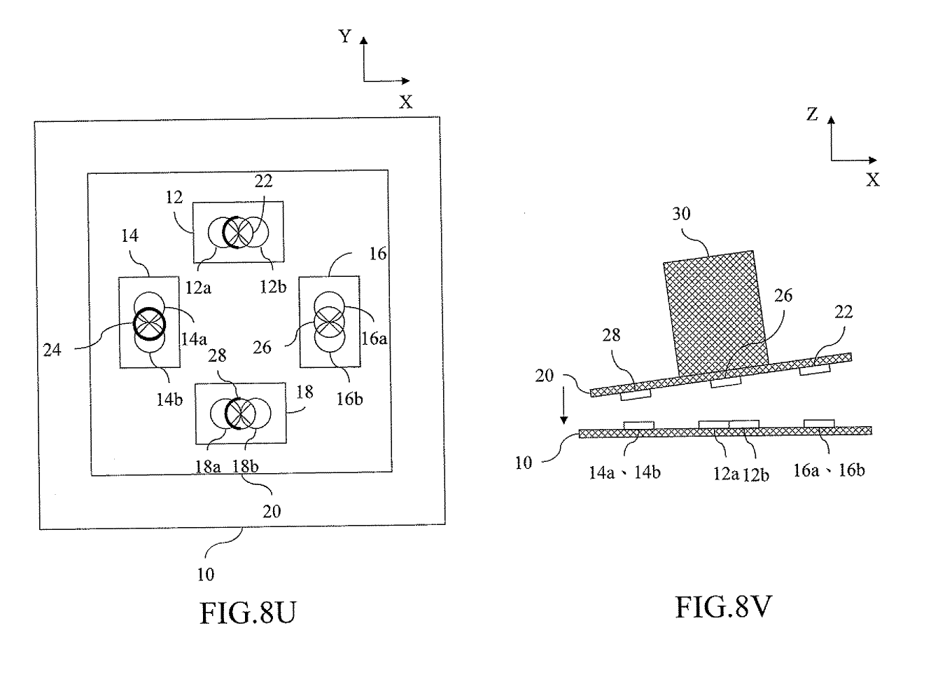

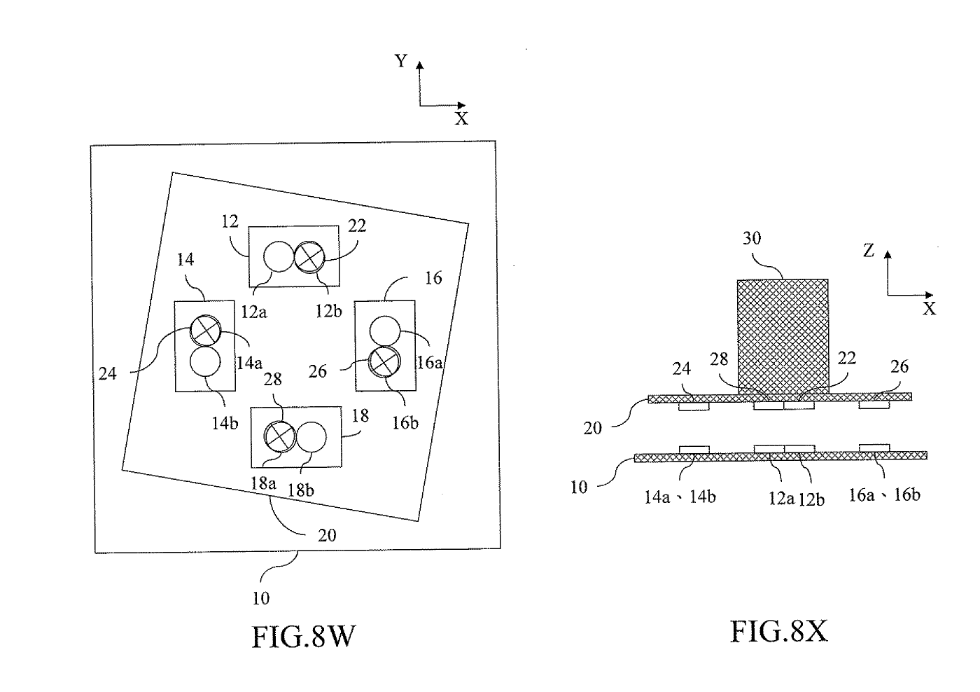

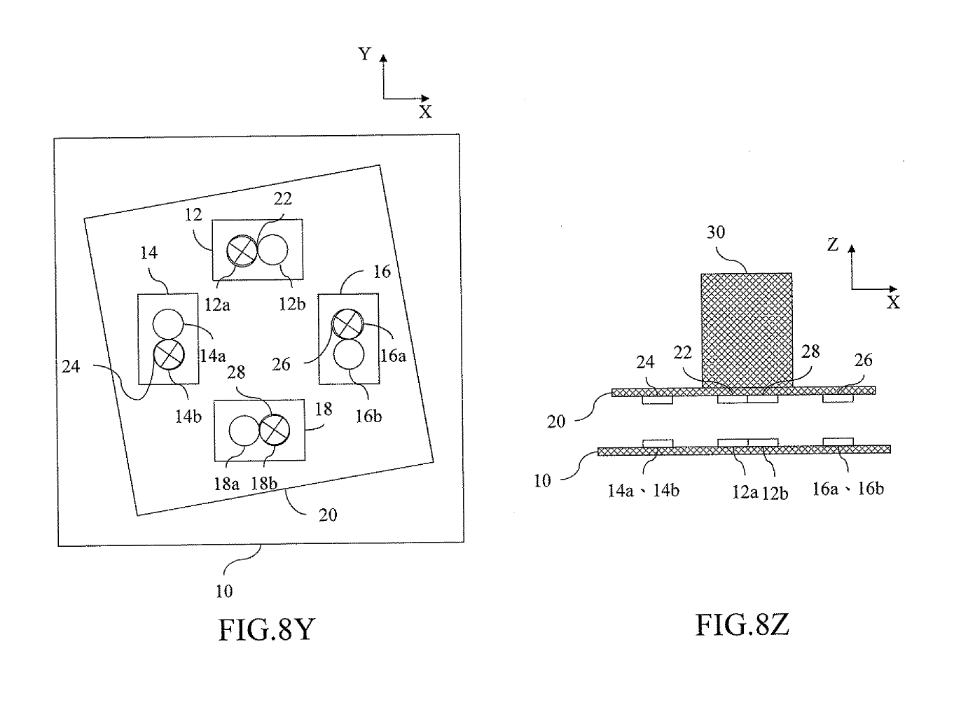

FIG. 8A and FIG. 8B are schematic diagrams of relative positions according to the fourth embodiment of the present disclosure. A bar 30 is provided on the second element 20. A user may operate the bar 30 to enable the second element 20 to perform a multi-axial motion with respect to the first element 10.

The first transmitting coil 22, the second transmitting coil 24, the third transmitting coil 26, and the fourth transmitting coil 28 are disposed in a one-to-one manner with the first sensing unit 12, the second sensing unit 14, the third sensing unit 16, and the fourth sensing unit 18. Furthermore, the first transmitting coil 22 is disposed over and between the first receiving coil 12a and the second receiving coil 12b; the second transmitting coil 24 is disposed over and between the third receiving coil 14a and the fourth receiving coil 14b; the third transmitting coil 26 is disposed over and between the fifth receiving coil 16a and the sixth receiving coil 16b, and the fourth transmitting coil 28 is disposed over and between the seventh receiving coil 18a and the eighth receiving coil 18b.

Relative relations between relative magnitudes (increased or reduced) of the signals received by the first receiving coil 12a, the second receiving coil 12b, the third receiving coil 14a, the fourth receiving coil 14b, the fifth receiving coil 16a, the sixth receiving coil 16b, the seventh receiving coil 18a, and the eighth receiving coil 18b and the received signals corresponding to the multi-axial motion may correspond to the “upward”, “downward”, “leftward”, “rightward”, “forward”, “backward”, “leftward rotation”, “rightward rotation”, “leftward inclination”, “rightward inclination”, “forward inclination”, and “backward inclination” operations respectively to generate twelve types of control signals. Relations between the twelve types of control signals and the multi-axial operation may be listed in the following table. People skilled in the art may enable the received signals to correspond to the output control signals by looking up the table.

| | the first | the second | the third | the fourth | the fifth | the sixth | the seventh | the eighth |
|---|---|---|---|---|---|---|---|---|
| | receiving | receiving | receiving | receiving | receiving | receiving | receiving | receiving |
| Operation | coil 12a | coil 12b | coil 14a | coil 14b | coil 16a | coil 16b | coil 18a | coil 18b |
| forward | smaller | smaller | larger | smaller | larger | smaller | smaller | smaller |
| leftward | larger | smaller | smaller | smaller | smaller | smaller | larger | smaller |
| backward | smaller | smaller | smaller | larger | smaller | larger | smaller | smaller |
| rightward | smaller | larger | smaller | smaller | smaller | smaller | smaller | larger |
| upward | smaller | smaller | smaller | smaller | smaller | smaller | smaller | smaller |
| downward | larger | larger | larger | larger | larger | larger | larger | larger |
| forward | larger | larger | larger | smaller | larger | smaller | smaller | smaller |
| inclination | | | | | | | | |
| leftward | larger | smaller | larger | larger | smaller | smaller | larger | smaller |
| inclination | | | | | | | | |
| backward | smaller | smaller | smaller | larger | smaller | larger | larger | larger |
| inclination | | | | | | | | |
| rightward | smaller | larger | smaller | smaller | larger | larger | smaller | larger |
| inclination | | | | | | | | |
| leftward | larger | smaller | smaller | larger | larger | smaller | smaller | larger |
| rotation | | | | | | | | |
| rightward | smaller | larger | larger | smaller | smaller | larger | larger | smaller |
| rotation | | | | | | | | |

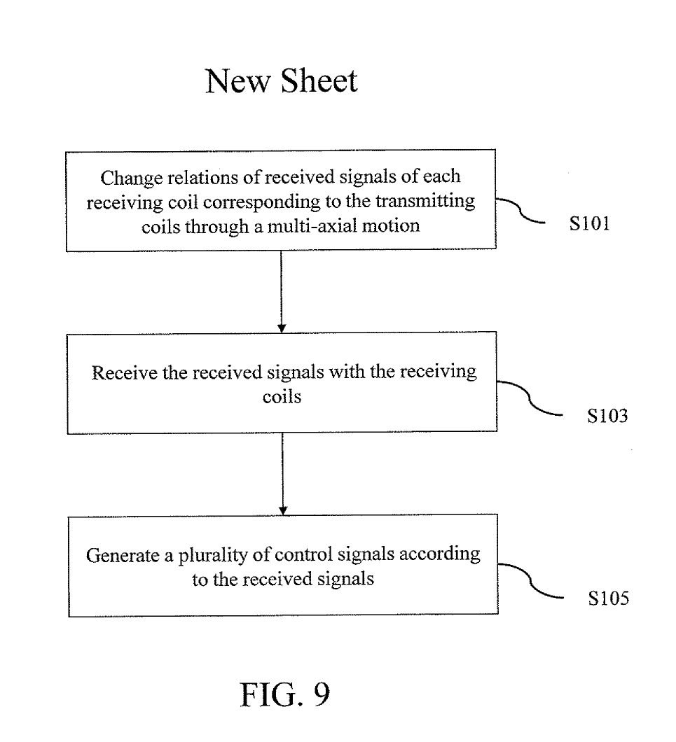

FIG. 9 is a flow chart of a 3D control method according to the present disclosure. The 3D control method is applicable to hardware architecture of the 3D control apparatus described in the first embodiment, the second embodiment, the third embodiment, or the fourth embodiment.

In Step S101, the magnitude of the received signals of each receiving coil is changed through the multi-axial motion between the first element 10 and the second element 20. Herein, the receiving coils may be the first receiving coil 12a to the sixth receiving coil 16b or the first receiving coil 12a to the eighth receiving coil 18b.

In Step S103, the transmitting coils on the second element 20 transmit signals to the receiving coils, which may receive the corresponding received signals transmitted by the transmitting coils.

In Step S105, the receiving coils generate a plurality of control signals according to the received signals wherein the receiving coils generate six, ten, or twelve types of control signals according to relative magnitudes of the received signals. Herein, the manner of generating the control signals is the same as those described in the first embodiment, the second embodiment, the third embodiment, or the fourth embodiment, and reference can be made thereto.

According to the 3D control system and the 3D control method provided by the present disclosure, the present disclosure requires only a small number of transmitting coils and receiving coils to generate up to twelve types of control signals according to the relations of the received signals of the receiving coils to perform 3D control. Therefore, the 3D control apparatus for the computer input device disclosed by the present disclosure has a rather simple structure, which not only saves the manufacturing cost, but also effectively reduces the volume to be more easily integrated with other computer peripheral apparatuses.

What is claimed is:

1. A three-dimensional (3D) control apparatus for a computer input device, comprising:
at least three sensing units, each of which has two adjacent receiving coils; and
at least one transmitting coil, disposed among the three sensing units for performing a multi-axial motion with respect to the three sensing units for changing relations of received signals of each receiving coil in the three sensing units for control.

2. The 3D control apparatus for the computer input device according to claim 1, wherein the three sensing units perform control according to relative magnitudes of the received signals of the plurality of receiving coils.

3. A three-dimensional (3D) control apparatus for a computer input device, comprising:
a first element, comprising at least three sensing units, each of which has two adjacent receiving coils; and
a second element, comprising at least one transmitting coil disposed among the three sensing units,
wherein the first element is disposed in a relation of being capable of performing a multi-axial motion with respect to the second element, the multi-axial motion changes relations of received signals of each receiving coil in the three sensing units corresponding to the transmitting coil, and the three sensing units generate at least six types of control signals according to the received signals.

4. The 3D control apparatus for the computer input device according to claim 3, wherein the three sensing units generate the at least six types of control signals according to relative magnitudes of the received signals of the plurality of receiving coils.

5. A three-dimensional (3D) control apparatus for a computer input device, comprising:
a first element, comprising at least three sensing units each of which has two adjacent receiving coils; and
a second element, comprising at least three transmitting coils disposed in a one-to-one manner with the three sensing units,
wherein the first element is disposed in a relation of being capable of performing a multi-axial motion with respect to and the second element, the multi-axial motion changes relations of received signals of each receiving coil in the three sensing units corresponding to the transmitting coils, and the three sensing units generate at least ten types of control signals according to the received signals.

6. The 3D control apparatus for the computer input device according to claim 5, wherein the three sensing units generate the at least ten types of control signals according to relative magnitudes of the received signals of the plurality of receiving coils.
